(19) United States
(12) Patent Application Publication
(10) Pub. No.: US 2016/0328393 A1
(43) Pub. Date: Nov. 10, 2016

(54) DATE DETERMINATION IN NATURAL LANGUAGE AND DISAMBIGUATION OF STRUCTURED DATA

(71) Applicant: International Business Machines Corporation, Armonk, NY (US)

(72) Inventors: Daniel Levy, Ottawa (CA); Michael J. Moniz, Bradford (CA); Graham A. Watts, Ottawa (CA)

(21) Appl. No.: 14/702,892

(22) Filed: May 4, 2015

(51) Int. Cl. G06F 17/28; G06F 17/27

(52) U.S. Cl. CPC G06F 17/2818; G06F 17/2715

(57) ABSTRACT

A computer-implemented method and system for date disambiguation includes receiving a text using a computer. An event is identified and a date candidate is detected from the text. A date pattern is identified based on the date candidate. A data set is identified based on the event. A plurality of data columns, from the data set, is identified and scored by applying a statistical analysis based on normalizing variances, the score being related to a degree of variation of information. A data column is selected based on the score.

### BACKGROUND

The present disclosure relates generally to the field of computer systems, and more particularly to detection of dates, and date ranges within structured data.

Natural language interfaces rely on the ability of the system to fully understand what the user is trying to achieve. This means the natural language interface needs to correctly recognize and match items from a question to the underlying data the system accesses to answer the user's questions. This problem is further complicated by the inherent ambiguity present in natural language. For instance, date references can be specified in numerous different ways within an English sentence. Since date-data is nearly universally required to answer business-intelligent questions, it is imperative that such dates are recognized, and matched to the underlying data to correctly answer these types of questions. Many existing systems simply have a few patterns that are used to recognize date information which matches a particular form.

### SUMMARY

It may be desirable to implement a method, system, and computer program product which considers various aspects of natural language and detects the dates and/or date ranges and underlying data within a stream of received words.

An embodiment of the present disclosure provides a method for date disambiguation in natural language by receiving words identifying an event and dates from a user, detecting a date candidate from the words, identifying a date pattern based on the date candidate, identifying a data set based on the event, identifying data columns from the data set, identifying a score for each of the data columns by applying a statistical analysis based on the date pattern, and selecting a data column based on the score.

According to a further embodiment, a system for date disambiguation in natural language by receiving words identifying an event and dates from a user, detecting a date candidate from the words, identifying a date pattern based on the date candidate, identifying a data set based on the event, identifying data columns from the data set, identifying a score for each of the data columns by applying a statistical analysis based on the date pattern, and selecting a data column based on the score.

According to another embodiment, a computer program product for date disambiguation in natural language by receiving words identifying an event and dates from a user, detecting a date candidate from the words, identifying a date pattern based on the date candidate, identifying a data set based on the event, identifying data columns from the data set, identifying a score for each of the data columns by applying a statistical analysis based on the date pattern, and selecting a data column based on the score.

### BRIEF DESCRIPTION OF THE SEVERAL VIEWS OF THE DRAWINGS

FIG. 1A is a schematic block diagrams depicting an exemplary computing environment for a date disambiguation program, according to an aspect of the present disclosure.

FIG. 1B is as schematic block diagram depicting components of a date disambiguation program, according to an aspect of the present disclosure.

FIG. 2 is a flowchart depicting operational steps of a method for a date disambiguation program, in accordance with an embodiment of the present disclosure.

FIG. 3 is a flow chart depicting the operation of year resolution for the patterning module of a date disambiguation program in accordance with an embodiment of the present disclosure.

FIG. 4 is a flowchart depicting operational steps of a method for parsing module of a date disambiguation program, in accordance with an embodiment of the present disclosure.

FIG. 5 is schematic block diagram depicting a graphical representation of contents of a data column in accordance with an embodiment of the present disclosure.

FIG. 6 is a block diagram of internal and external components of computers and servers depicted in FIG. 1 in accordance with an embodiment of the present disclosure.

### DETAILED DESCRIPTION

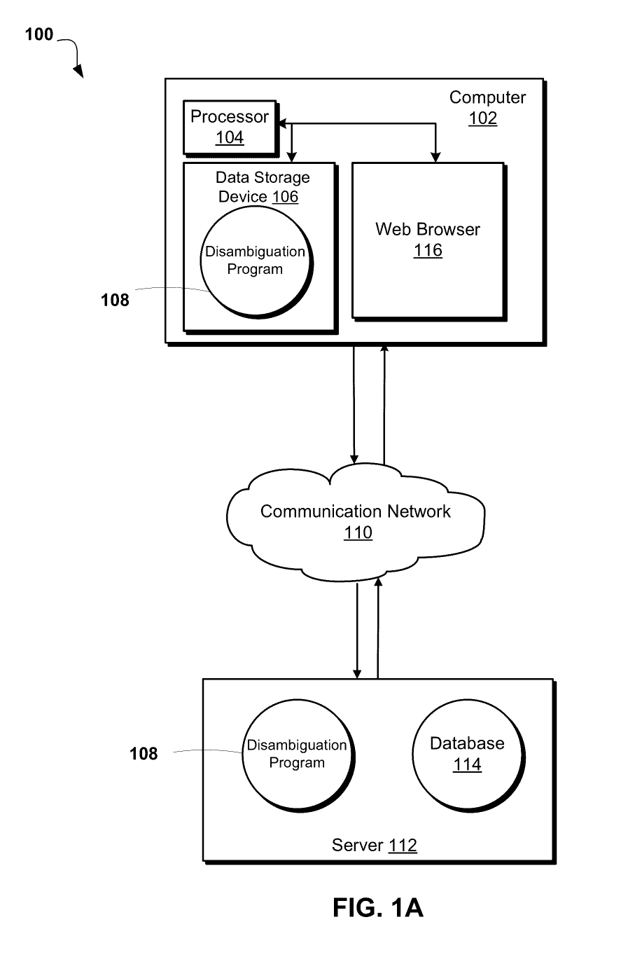

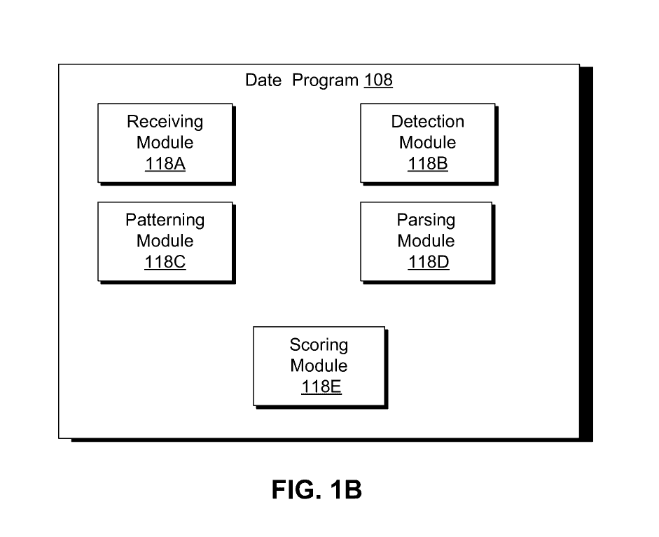

FIG. 1A is a schematic block diagram depicting an exemplary computing environment 100 for date disambiguation. In various embodiments of the present disclosure a computing environment 100 includes a computer 102 and a server 112 connected over a communication network 110.

The computer 102 may include with a processor 104 and a data storage device 106 that is enabled to run a date disambiguation program 108 and a web browser 116 in order to display the result of a program on server 112 such as date disambiguation program 108 communicated by a communication network 110. Non-limiting examples of a web browser may include: Firefox®, Explorer®, or any other web browser. All brand names and/or trademarks used herein are the property of their respective owners.

The computing environment 100 may also include the server 112 with the database 114. The server 112 may be enabled to run a date disambiguation program 108. The communication network 110 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. communication network 110 may also include a number of different types of networks, such as, for example, an intranet, a local area network (LAN), or a wide area network (WAN).

It should be appreciated that FIG. 1A provides only an illustration of one implementation and does not imply any limitations with regard to the environments in which different embodiments may be implemented. Many modifications to the depicted environments may be made based on design and implementation requirements.

The computer 102 may communicate with the server 112 via the communication network 110. The communication network 110 may include connections, such as wire, wireless communication links, or fiber optic cables.

The computer 102 and the server 112 may be, for example, a mobile device, a telephone, a personal digital assistant, a netbook, a laptop computer, a tablet computer, a desktop computer, or any type of computing device capable of running a program and accessing a network. A program, such as a date disambiguation program 108 may run on the client computer 102 or on the server 112.

Referring now to FIG. 1B, the components of the date disambiguation program 108, are illustrated. The date disambiguation program 108 may include a receiving module 118A, detection module 118B, patterning module 118C, parsing module 118D, and scoring module 118E. The receiving module 118A may receive one or more digital text streams, such as one or more words. The detection module 118B may detect one or more dates within the words received by the receiving module 118A. The patterning Module 118C may, using the detected date, create a date range. The parsing module 118D may unify the different types of date candidates. The scoring module 118E may analyze different data sets within the date range, and identify a score for data columns within the data sets.

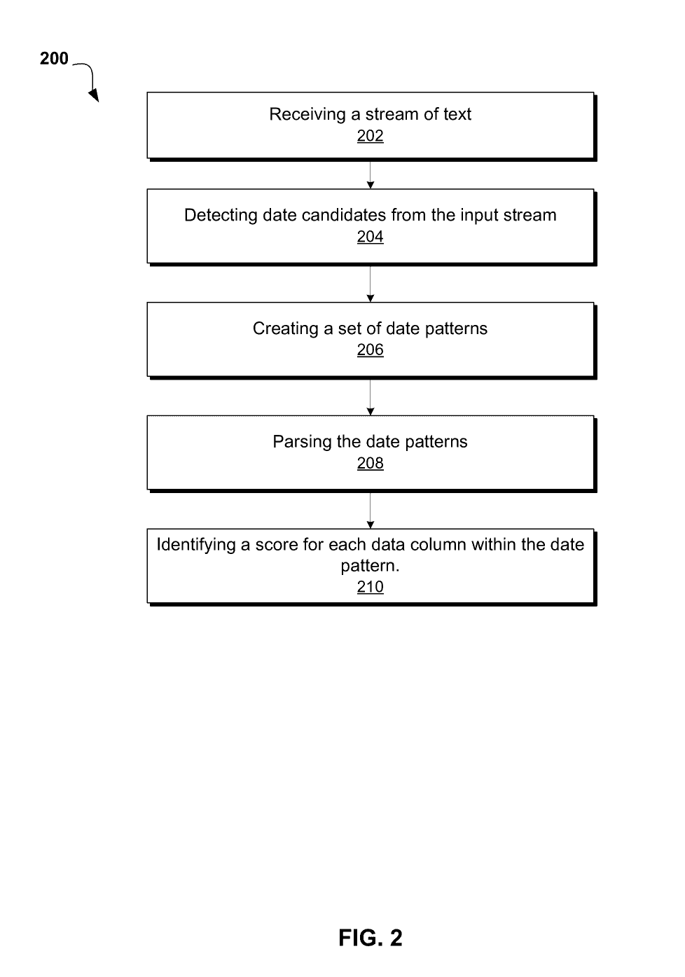

FIG. 2 is a flowchart depicting operational steps of a method for a date disambiguation program 108, in accordance with an embodiment of the present disclosure. In this embodiment, the question “show me how we have been doing since February” is analyzed and a data column is scored, selected, and presented to the user.

In reference to FIG. 1, steps of method 200 may be implemented using one or more modules of a computer program, for example, date disambiguation program 108, and executed by a processor of a computer, such as computer 102.

It should be appreciated that FIG. 2 does not imply any limitations with regard to the environments or embodiments which may be implemented. Many modifications to the depicted environment or embodiment shown in FIG. 2 may be made.

At 202, receiving module 118A may receive a digital text stream comprising one or more words, numbers, and/or metadata associated with the words. Receiving module 118A may receive the word(s) and/or metadata associated with the words from a user or a computer implemented system. Non-limiting examples of an input source may be spoken words, typed text, or inputting a corpus electronically from a computer implemented source such as an electronic device (e.g. cell phones, tablets, or other electronic devices with speech recognition ability).

In this embodiment, receiving module 118A, receives a sentence (“show me how we have been doing since February”) from a user. In this embodiment, user speaks the words into an input device such as a microphone connected to a computer such as the computer 102.

At 204, detection module 118B may detect the existence of date (or a word indicating a date) within the received sentence. Detection module 118B may identify and extract many different types of data/time references by using a focal point such as a month within the sentence to identify the locations of the date/time references in the sentence. Detection module 118B may break the received string of words into a set of tokens. A token is a short piece of text or a fragment of a sentence usually comprising of words. A word is a smallest element that may be uttered in isolation with semantic or pragmatic content (i.e. literal or practical meaning). Detection module 118B may analyze each token for the properties of a date representation. Non-limiting examples of the properties may include:
normalized representation of a month. It should be noted that this can be done for any language; for example January (English), Janvier (French).
one, two or four digit numbers within appropriate ranges; for example 1-9, 10-31
day of the week; for example Monday . . . .
temporal concept such as “quarter”; for example “Compare my sales from the last quarter”.

In this embodiment, detection module 118B detects the date within the received question of “show me how we have been doing since February”. Detection module 118B, in this embodiment, breaks down the received question into 9 tokens which consist of a single word within the received question (“show”, “me”, “how”, “we”, “have”, “been”, “doing”, “since”, and “February”). Detection module 118B recognized February as a normalized representation of the month of February and detects the word February as a date within the received question.

Referring now to block 204, patterning module 118C may create a date range for the dates detected within the received words. In order to create a date range, patterning module 118C may unify the year of the detected dates, and determine date restrictions present in the received words. Patterning module 118C may, based in the above mentioned steps, determine a date restriction. It should be noted that these steps may be executed in any order. In an embodiment, patterning module 118C may determine that the received words of “Feb to 4/6/15” has a date range of “2/1/2015-4/6/2015”.

Patterning module 118C may determine date restriction patterns. Date restrictions are any constraints or limitation on the detected dates within the received words. Patterning module 118C may detect the restrictions (if any). In an embodiment, patterning module 118C may detect sensitive words which indicate date restriction patterns from a previously defined sensitive words banks which includes a list of all the date restrictions. Non-limiting example of these words may include: on, before, after, since, until, so far, and between. Patterning module 118C may assign each of the words with a particular format of the data pattern restriction. For example, in an embodiment, before X may be designated a (t<X) value wherein t represents the date range and X represents the date which is detected within the received words; in this example, before 1/4/1980 may result in a (t>1/4/1980). In other embodiments, other restrictive words may be assigned to different values. For example after x may be assigned to a (t<X) value, in X may be assigned to (t=X) value, and between X and Y may be assigned a (t>=X̂t<=Y). It should be mentioned that the value of date may be as broad as a year or as specific as hours and seconds.

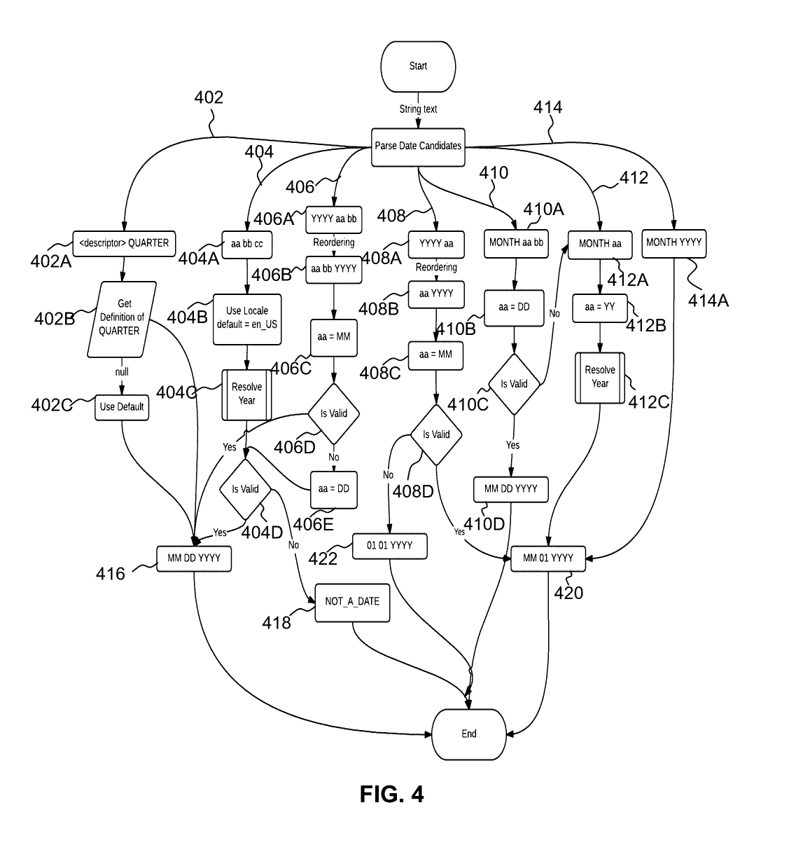

Patterning module 118C may also unify the year in order to ease the process of determining date ranges. This process is explained further in FIG. 4.

In this embodiment (“how are we doing since February”), patterning module 118C detects the token “since” as a restrictive pattern of a continuous nature and creates a pattern of February 2015 to present day (i.e. February 2015 to 4/07/2015 assuming that this question is asked on 4/07/2015). Furthermore, by using the word “we” user is indicating to his business. In this embodiment, date disambiguation program 108 is used to analyze data for user's business, therefore date disambiguation program 108 choses a data set associated with user's business.

Referring now to block 208, parsing module 118D may parse through the dates (i.e. all calendar dates) and unify the date format and resolve any ambiguity. This may give us a predefined ordering of month and date. Operation of parsing module 118D will be explained in more details in FIG. 4.

Parsing module 118D may make some assumptions about the restrictions. In an embodiment, when only a particular month is detected, parsing module 118D may assume the date as the beginning of that month. In another embodiment, when no particular restriction is imposed (i.e. sales for the quarter), parsing module 118D may assume that user is pointing to the present quarter. Furthermore, in another embodiment, parsing module 118D may assume that “between March 2014 and June 2014” is between March 1, 2014-June 30, 2014. Parsing module 118D may also assume single data point as a range due to continuous nature of dates by translating words (such as on, at, and all) into a continuous range. In an embodiment, parsing module 118D may translate “in 2014” to a range of January/1/2014-December/31/2014, or “in March 2014” to March 1, 2014-March 31, 2014, or “so far” to beginning of the year to the present date. Patterning module 118C may also unify the year for the detected dates within the received words. These process are explained further in FIG. 4.

In this embodiment, parsing module 118D parses through the date range calculated by the pattering module 118C (“February 2015 to 4/07/2015”) and transforms it to 2/1/2015-04/07/2015).

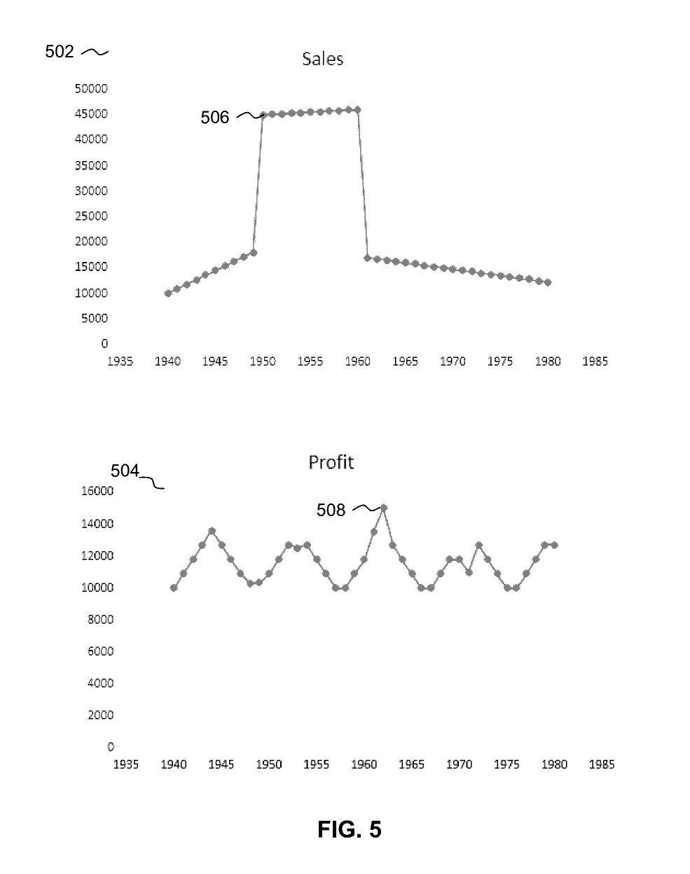

Referring now to block 210, scoring module 118E may analyze various data columns within the date range and score each data column. The score is a by-product of degree of variation of data, more specifically the score indicates a quantified level on how well the user inputted range is represented by a given data column. Said representation is determined by having distributed data within that date range and on average how different that range of data is compared to the entire column of data. The data column is an array of aggregated statistical information within a particular date range, wherein the statistical information comprises of a particular date within the date range and one or more of corresponding information and occurrences. Data columns are explained in more details in FIG. 5.

It should be noted that when user inquires for a specific data column, date disambiguation program 108 may provide user with an answer specific to said data column. For example, in an embodiment, if the user asks “how was the sales on July 4^{th}, 2015”, then disambiguation program 2015 may provide the sales numbers on Jul. 4^{th}, 2015. It should be noted that date disambiguation program 108 may also analyze other data columns (such as profits, revenue, overhead . . . ) and provide user with those data columns as well. This is ameliorative to human's brain's limited capacity to connect certain unexpected data. In other words, and in one embodiment, while the user might not be able to connect the profit margin to certain advertising or other data columns which the user might not be familiar with, date disambiguation program 108 may make that connection and provide user with said data columns even though user hasn't specifically asked for said data column.

At block 210, scoring module 118E may determine the score for the data column within the date range by normalizing variances of data within the data column. Scoring module 118E may analyze the data column locally within the date range. Scoring module 118E may assume that diverse data is better than repetitive data. Scoring module 118E may calculate the average count of each date value within the date range, calculate the variance of the date range, and normalize variance from [0, 1]. This measure is a local score or M1. Scoring module 118E may also analyze the data column globally. Scoring module 118E may assume that the more atypical the data is in the range the better. Scoring module 118E may calculate the average count of each date value in the dataset, compute the absolute difference between the global and local averages, and divide the result by the global average. This measure is a global score or M2. The higher value of M2 implies atypical point in the data which is a positive contributor to the global score. Scoring module 118E may also determine the size of the data range. For this the underlying assumption made by scoring module 118E is that the more data indicates better quality of score. Scoring module 118E may normalize all of the sizes for columns from [0, 1] referring to this measure as M3.

Scoring module 118E may use M1-M3 to determine an overall score for a particular data column. In an embodiment, scoring module 118E may use the following formula to calculate an overall score:

Overall Score=M3*(1−M2)+M2=norm(size)*(1−norm(local_variance))+abs(global_average−local_average)/global_averag

Scoring module 118E may repeat the above-mentioned steps and calculate an overall score for each data column. In an embodiment, scoring module 118E may also rank plurality of the data columns based on their overall score and present the data columns to the user based on their respective ranks. In one embodiment, scoring module 118E only present the highest ranked data column to the user.

In this embodiment, scoring module 118E may search within above-mentioned data columns (i.e. profit vs. time; it may be that a data column represents revenue to overhear ratio vs. time, overhead vs. time, revenue vs. time). Scoring module 118E scores and ranks all the data columns and provide user with three data columns (profits vs. time, revenue/overhead vs. time, and employee overtime vs. time).

It must be appreciated that when a user asks for a specific data column, date disambiguation program 108 may provide user with said data column. Furthermore, it may be that when user is ambivalent or ambiguous regarding the data columns (e.g. in the present embodiment when the user asks “how are we doing since February”) that date disambiguation program 108 may provide user with multiples highly scored data columns. For example, if the user inquires “how is the sales since February” then in one embodiment date disambiguation program 108 may only provide user with a sales data column. In another embodiment, when presented the same inquiry, date disambiguation program 108 may provide user with highly-scored data column in addition to the sales data column. For example, date disambiguation program 108 may provide advertising data column and sales data column to the user even though the user only asked for the sales data column. In this embodiment, scoring module 118E scores multiple data columns and presents the user with profit vs. time, sales vs. time data columns. This is due to the fact that these two data columns have been identified as having a higher score than other data columns within the data set.

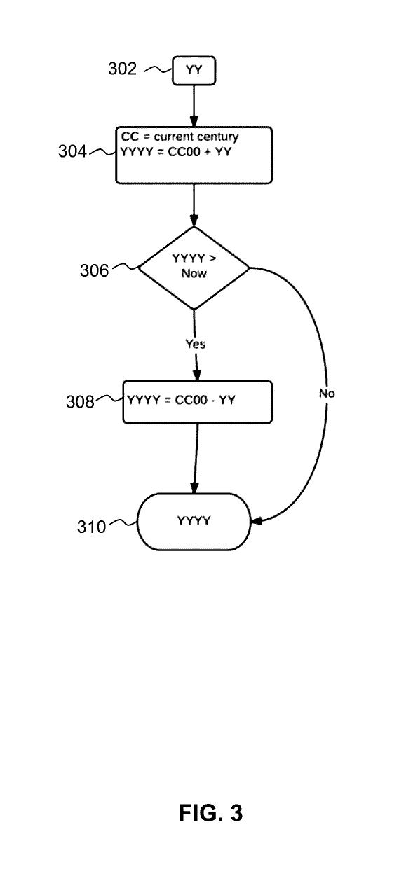

FIG. 3 depicts the operation of year resolution of patterning module 118C. Patterning module 118C may, create a four-digit year number while the received input words (which are detected by the detection module 118B) may be a two digit number. In this embodiment, patterning module 118C resolves the year 99 into 1999.

At 302, patterning module 118C receives two digits representing a particular year. The received two digits are represented by YY. At 304, patterning module 118C may add the current century (represented by CC) to YY thus changing the potential year (represented by YYYY). YYYY is the potential year which is calculated as CCYY. At 306, patterning module 118C may check the potential year (YYYY) against the current year. If the potential year is less than the current year, then the potential year is correct and YY is resolved into YYYY, if YYYY is a greater number than the current year, then at 308, patterning module 118C may change CC to the previous century.

In this embodiment, “first quarter of 15” is received by patterning module 118C. Patterning module 118C adds the current century (2000) to the year received (15) and resolves the year to 2015.

FIG. 4 is a flowchart which depicts the operation of parsing module 118D. Parsing module 118D may receive date candidates in various input formats of dates and transform said formats into a unified format. Flow chart of FIG. 4 comprises of 7 branches (402,404,406,408,410,412, and 414). Each one of these branches, as explained below, represents one format for which a user may input a date candidate. Parsing module 118D, in an embodiment, may transform these various formats into a MMDDYYYY format which represents the standard American format of Month/Date/Year.

At branch 402 (including 402A-C and 416), parsing module 118D may receive the date candidate as a description of a quarter. Branch 402 may first get the definition of a quarter (e.g. the definition of certain business terms such as quarter may be preloaded into the parsing module 118D) and designate a starting date for the quarter. In an embodiment, parsing module 118D may receive the date candidate as “this quarter”. Parsing module 118D may, using today's date 4/6/2015, identify that the user is implying the second quarter of 2015 with starting date of 4/1/2015 and ending date of 6/30/2015. Parsing module 118D may designate a 4/1/2015 to this date candidate.

At branch 404 (including 404A-D, 416, and 418), parsing module 118D may receive the date candidate as two digit numbers. Parsing module 118D may use local standards to determine whether the first two digits and the second set of two digits refer to the month or the day. For example, in an embodiment, parsing module 118D may apply the European standard (e.g. day/month/year) when analyzing dates regarding European documents, data sets, or users. Branch 404 may also resolve the year into a four-digit numbers (FIG. 3. Branch 404 may also validate the date. In one embodiment, branch 404 may find that a number 23 used as the indicator of the month is not valid. In another embodiment, branch 404 may receive a date such as 14 06 12. In this embodiment, branch 404 may use the European model of day/month/year and analyze that the date candidate into a format of 6/14/2012. It should be noted that number 14 would not be valid to use for the month category under the validity test depicted in 404D because there are only 12 months in a year.

At branch 406 (including 406A-E, 404D, 418 and 416) parsing module 118D may receive the date candidate as two digit numbers in a format of year/two digits/two digits. In an embodiment parsing module 118D may not at first be able to determine which two digits are entered as month indicator and which two digits are entered as day indicator. Parsing module 118D may first assume that the first two digits are a month indicator. Parsing module 118D may also check the validity of said assumption (block 406D). For example a number larger than 12 may fail said validity test because no number larger than 12 may be used to indicate a month. In that embodiment, parsing module 118D may assume the second two digits as the month. Parsing module 118D, at block 404D check the validity of that assumption as well. Branch 406 may transform the number into month/date/year as depicted in block 416.

In an embodiment, branch 406 may receive a date such as 2012 14 12. In this embodiment, branch 406 may assume that 14 is a month indicator and check the validity of that assumption. Because 14 is a larger number than 12 the validity test fails and therefore branch 406 assumes that 14 is a day indicator. As a result, branch 406 transforms the date candidate into 12/14/2012.

At branch 408 (including 408A-D, 422, and 420) parsing module 118D may receive the date candidate as four digits followed by two digits (e.g. 2015 9). In an embodiment parsing module 118D may not at first be able to determine whether the two digit number is a day or month indicator. Branch 408 may first reorder the received date candidate as two digits followed by the four digits. Branch 408 may also assume that the first two digits are a month indicator. Branch 408 may also check the validity of this assumption (block 408D). For example a number larger than 12 may fail said validity test because no number larger than 12 may be used to indicate a month. In that embodiment, branch 408 may assume the second two digits as the month. If the assumption passes the validity test of block 408D, branch 408 may transform the date into MM/01/YYY (i.e. parsing module 118D may assume that the user is indicating the first of the month and has left out the exact day indicator). If said assumption doesn't pass the validity test of block 408D, parsing module 118D may assume that the user is indicating the first day of the first month of the year YYYY (block 422).

At branch 410 (including 410A-D) parsing module 118D may receive a date candidate as month and two sets of two digits numbers (e.g. February 01 98). In an embodiment, parsing module 118D may assume that the first two digits are a day indicator. Branch 410 may also check the validity of this assumption (block 410C). For example a number bigger than 31 may fail said validity test because no number larger than 31 may be used to indicate a month. In that embodiment, branch 410 may assume the second set of two digits as a year indicator. If the assumption passes the validity test of block 410C, branch 408 may transform the date into MM DD YYYY (month/Day/Year). If the validity test of 410C fails, parsing module 118D may transfer the date candidate to branch 412.

At branch 412 (including 410A-C) parsing module 118D may receive the date candidate as Month and one sets of two digits numbers (e.g. February 98). In an embodiment parsing module 118D may assume that the two digits are a year indicator. Branch 410 may also resolve the year and transform into MM 01 YYYY (i.e. month/ 01/year). It must be appreciated that branch 412 may assume, due to the lack of information about a specific day indicator, assume that the date candidate is indicating the beginning of the month. For example, in an embodiment, February 98 may be transformed into 02/01/1998.

At branch 414 (including 414A and 420) parsing module 118D may receive the date candidate as Month and a four digit year indicator (e.g. February 2014). In an embodiment branch 414 may assume, due to the lack of information about a specific day indicator, assume that the date candidate is indicating the beginning of the month. For example, in an embodiment, February 98 may be transformed into 02/01/1998.

FIG. 5 is a schematic block diagram depicting a graphical representation of content of a data column. In this embodiment, content of a “sales vs. time”, “profits vs. time” and “overhead vs. cost per unit” are depicted.

A data column comprises of one or more arrays of aggregated statistical information within a data set. A data set is any collection of related sets of information. In an embodiment, a data set may correspond to the contents of a single or multiple statistical data matrix, where every column of the table represents a particular variable, and each row corresponds to a given member of the data set in question. The data set may list values for each of the variables. The data set may also comprise of data for one or more members and corresponding variables. In other words a data set is data related to an event. Furthermore, a data column is an array of the information contained within a data set. Non-limiting examples of a data column may comprise sales, profits, cost per unit, revenue, overhead.

It must also be appreciated that arrangement of array(s) of aggregated statistical information may comprise statistical information of one or more (or a derivative concept of) categories within a data set and not limited to two categories. For example, while most common data columns may be, for example, profit vs. time; it may be that a data column represents revenue to overhear ratio vs. time.

In this embodiment, graph 502 depict a graphical representation of a data column. Graph 502 represents a sales data column within a business data set. The business data set is a collection of all information (raw and derivative) relevant to that particular business. In this embodiment, the data set includes, sales, profit, revenue, and advertising information, and overhead, number of employees, productivity, and miscellaneous costs related to a certain event. In this embodiment, several data columns exist. Non-limiting examples of data columns, in this embodiment, include sales vs. profit, overhead vs. profit, advertising costs vs. sales. Graph 502 comprises of sales figures on the Y-Axis and time in the X-Axis. Graph 504 represent a data column of sales vs. time. Graph 504 represent a profit vs. time data column with profits represented in the Y-axis and time in the X-axis.

For instance, data point 506 corresponds to two coordinates. On the X-axis (i.e. the principal or horizontal axis of a system of coordinates, points along which have a value of zero for all other coordinates) data point 506 corresponds to the year 1950. On the Y-axis (i.e. the secondary or vertical axis of a system of coordinates, points along which have a value of zero for all other coordinates) data point 506 corresponds to 45000 dollars. Therefore within this data column, at year 1950 there has been a sales figure for 45000 dollars. Similarly data point 508 corresponds to a profit of 15000 dollars in year 1962.

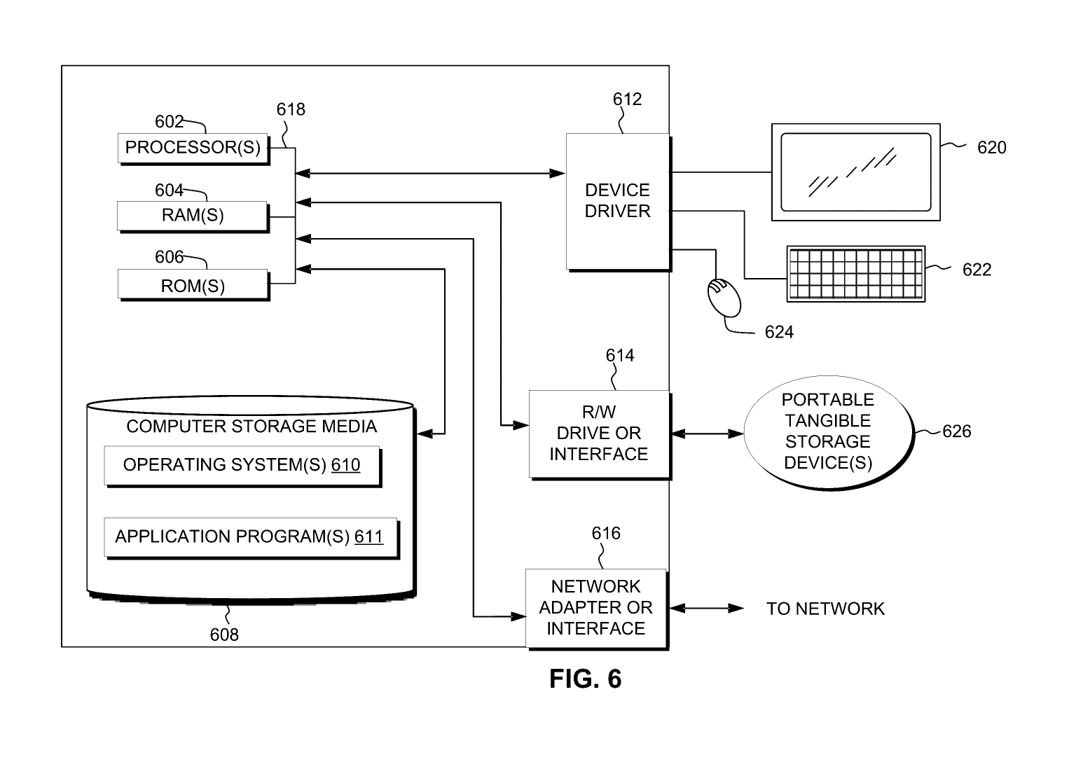

Referring now to FIG. 6 of components a computer system, for example server 112 and data source 120, of distributed data processing environment 100 of FIG. 1, in accordance with an embodiment of the present disclosure.

Server 112 may include one or more processors 602, one or more computer-readable RAMs 604, one or more computer-readable ROMs 606, one or more computer readable storage media 608, device drivers 612, read/write drive or interface 614, network adapter or interface 616, all interconnected over a communications fabric 618. Communications fabric 618 may be implemented with any architecture designed for passing data and/or control information between processors (such as microprocessors, communications and network processors, etc.), system memory, peripheral devices, and any other hardware components within a system.

One or more operating systems 610, and one or more application programs 611, are stored on one or more of the computer readable storage media 608 for execution by one or more of the processors 602 via one or more of the respective RAMs 604 (which typically include cache memory). In the illustrated embodiment, each of the computer readable storage media 608 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 112 and computer 102 may also include an R/W drive or interface 614 to read from and write to one or more portable computer readable storage media 626. Application programs 611 on server 112 and computer 102 may be stored on one or more of the portable computer readable storage media 626, read via the respective R/W drive or interface 614 and loaded into the respective computer readable storage media 608.

Server 112 may also include a network adapter or interface 616, such as a TCP/IP adapter card or wireless communication adapter (such as a 4G wireless communication adapter using OFDMA technology). Application programs 611 on server 112 and may be downloaded to the computing device from an external computer or external storage device via a network (for example, the Internet, a local area network or other wide area network or wireless network) and network adapter or interface 616. From the network adapter or interface 616, the programs may be loaded onto computer readable storage media 608. The network may comprise copper wires, optical fibers, wireless transmission, routers, firewalls, switches, gateway computers and/or edge servers.

Server 112 and computer 102 may also include a display screen 620, a keyboard or keypad 622, and a computer mouse or touchpad 624. Device drivers 612 interface to display screen 620 for imaging, to keyboard or keypad 622, to computer mouse or touchpad 624, and/or to display screen 620 for pressure sensing of alphanumeric character entry and user selections. The device drivers 612, R/W drive or interface 614 and network adapter or interface 616 may comprise hardware and software (stored on computer readable storage media 608 and/or ROM 606).

While the present invention is particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1.-6. (canceled)

7. A computer system for date range disambiguation, the computer system comprising:
one or more computer processors;
one or more computer-readable storage media;
program instructions stored on the computer-readable storage media for execution by at least one of the one or more processors, the program instructions comprising:
instructions to receive a text, the text identifying an event;
instructions to detect a date candidate from the text;
instructions to identify a date pattern based on the date candidate, the date pattern comprises a calendar date range;
instructions to identify a data set based on the event, the data set comprises a collection of information based on the event;
instructions to identify a plurality of data columns from the data set, each of the plurality of data columns comprising an array of aggregated statistical information regarding the event within the date pattern;
instructions to identify a score for each of the data columns by applying a statistical analysis based on the date pattern wherein the statistical analysis is based on normalizing variances, the score being related to a degree of variation of information; and
instructions to select a data column based on the score.

8. The computer system of claim 7, wherein the instructions to select is based on a highest score.

9. The computer system of claim 7, wherein the score is based on:
instructions to determine a first average count, wherein the first average count is an average count of each date value within the date range;
instructions to determine a second average count, wherein the second average count is an average count of each date value overall;
instructions to determine a variance within the date range; and
instructions to calculate a score based on higher than average count of and low variance within the date range.

10. The computer system of claim 7, wherein the text are a part of a question inquired by a user.

11. The computer system of claim 7, wherein the data column further comprises:
one or more arrays of aggregated statistical information within a particular date range, wherein the one or more arrays of statistical information comprises of a particular date within the date range and corresponding information.

12. The computer system of claim 7, further comprising:
instructions to rank the plurality of data columns based on their corresponding score value; and
instructions to present the plurality of data columns to user.

13. The computer system of claim 7, wherein the instructions to
identify the date pattern further comprises:
instructions to parse the date patterns, the instructions to parse includes unifying different formats of date ranges.

14. A computer program product for date range disambiguation, comprising a computer-readable storage medium having program code embodied therewith, the program code executable by a processor of a computer to perform a method comprising:
receiving a text, the text identifying an event;
detecting a date candidate from the text;
identifying a date pattern based on the date candidate, the date pattern comprises a calendar date range;
identifying a data set based on the event, the data set comprises a collection of information based the event;
identifying a plurality of data columns from the data set, each of the plurality of data columns comprising an array of aggregated statistical information regarding the event within the date pattern;
identifying a score for each of the data columns by applying a statistical analysis based on the date pattern wherein the statistical analysis is based on normalizing variances, the score being related to a degree of variation of information; and
selecting a data column based on the score.

15. The computer program product of claim 14, wherein the selecting is based on a highest score.

16. The computer program product of claim 14, wherein the score is based on:
determining a first average count, wherein the first average count is an average count of each date value within the date range;
determining a second average count, wherein the second average count is an average count of each date value overall;
determining a variance within the date range; and
calculating a score based on higher than average count of and low variance within the date range.

17. The computer program product of claim 14, wherein the data column further comprises:
one or more arrays of aggregated statistical information within a particular date range, wherein the one or more arrays of statistical information comprises of a particular date within the date range and corresponding information.

18. The computer program product of claim 14, further comprising:
ranking the plurality of data columns based on their corresponding score value; and
presenting the plurality of data columns to user.

19. The computer program product of claim 14, wherein the identifying the date pattern further comprises:
parsing the date patterns, the parsing includes unifying different formats of date ranges.

20. The computer program of claim 14, wherein the text are a part of a question inquired by a user.
